(19) United States
(12) Patent Application Publication
(10) Pub. No.: US 2013/0289215 A1
(43) Pub. Date: Oct. 31, 2013

(54) Clay Modified Rubber Composition and a Method for Manufacturing Same

(71) Applicant: Bridgestone Corporation, (US)

(72) Inventors: Xiaorong Wang, Hudson, OH (US); Victor J. Foltz, Akron, OH (US); Hiroyuki Fudemoto, Yokohama (JP)

(21) Appl. No.: 13/685,307

(22) Filed: Nov. 26, 2012

Related U.S. Application Data
(63) Continuation of application No. 11/077,595, filed on Mar. 11, 2005, now abandoned.
(60) Provisional application No. 60/557,412, filed on Mar. 29, 2004.

(51) Int. Cl. C08C 19/28

(52) U.S. Cl. CPC C08C 19/28
USPC 525/281

(57) ABSTRACT

A method to improve the cure properties of clay/rubber system. Clay has been exfoliated by ionic liquid surfactant and then added to rubber. The ionic liquid surfactant compatiblizes the clay and rubber and reduces gas permeability, without significantly impairing the rubber cure characteristics.

### CROSS-REFERENCE TO RELATED APPLICATIONS

This application is a continuation of U.S. non-provisional application Ser. No. 11/077,595, filed on Mar. 11, 2005, which, in turn, claimed the benefit of priority of U.S. provisional application No. 60/557,412, filed Mar. 29, 2004. U.S. non-provisional application Ser. No. 11/077,595 is incorporated herein by reference.

### BACKGROUND OF THE INVENTION

The present invention relates to a clay modified rubber composition. The present invention can provide a rubber composition having both improved cure properties and low gas permeability. The present invention also relates to a method for manufacturing a clay modified rubber composition. More particularly, the present invention relates to a method to improve the cure properties of clay modified butyl rubber.

Butyl rubber, typically a copolymer of isobutylene and isoprene, has a low degree of permeability to gases due to uniformity in the polyisobutylene portion of the butyl chains and the ease of packing provided by this uniformity. Not only can butyl rubber be 8-10 times more resistant to gas permeability than natural rubber, but also it has excellent resistance to heat, steam and water. Notwithstanding these desirable characteristics, in-chain unsaturation in butyl rubber, contributed by the presence of isoprene monomer units in the backbone, can be attacked by atmospheric ozone. These attacks may, over time, lead to oxidative degradation, which may subsequently lead to chain cleavage. This potential breakdown of the rubber could result in lower damping properties. One way to limit the impact of atmospheric gases on the butyl rubber structure is to further lower the gas permeability of the rubber composition.

It is known that the addition of clays to certain types of rubber compositions may be an effective way to lower gas permeability. To do so, the added clay must be of a small size, a condition traditionally achieved by exfoliation. Typical clays, prior to exfoliation, have a layered structure with a gap of about 0.1 nm between each layer and cations such as K⁺ and Na⁺ on the surface of each layer. The cations are attached by an ionic interaction with the negatively charged surface of the clay layers, and create a net neutral charge between clay layers.

Traditional exfoliation is generally conducted as follows. Clay is first swelled by placing it in water. Swelling takes place because the cations become solubilized in the water, leaving adjacent negatively charged clay layers. The adjacent clay layers are repulsed by their similar negative charges, resulting in gaps of up to about 3 nm between the layers. A surfactant, typically an organic ammonium salt such as cetyltrimethylammonium bromide or benzalkonium chloride, is then added to the swollen clay to form an organo-clay or clay/surfactant composition. The surfactant is attracted to the negatively charged surface of the clay, keeping the swelling state stable and forming gaps of about 5-10 nm between the layers. This organo-clay is then dried and subsequently placed in an organic solvent, such as toluene. A polymer such as polypropylene or nylon can then be added to further separate the layers of the clay, because the polymer is attracted to the surfactant and therefore also penetrates between clay layers. The large molecule size of the polymer serves to counteract any remaining Van der Waals interactions between the layers and the clay becomes fully exfoliated, i.e. separated into discrete layers.

However, in many cases, the procedure described above raises a problem. Particularly, the organic ammonium salts added to the clay, may damage the cure process of the rubber compounds, especially, for free radical cure, sulfur cure, ZnO cure and etc. The present invention provides a clay/surfactant/rubber system that, while substantially retaining desirable characteristics such as low gas permeability, has improved cure properties.

### SUMMARY OF THE INVENTION

The present invention relates to a method of making a clay modified butyl rubber composition comprising exfoliating a clay in the presence of an ionic surfactant and combining the exfoliated clay with a butyl rubber.

Another aspect of the invention relates to a rubber composition comprised of an exfoliated clay including an ionic surfactant and butyl rubber.

Still another aspect of the invention relates to a tire comprised of a butyl rubber including an exfoliated clay and an ionic surfactant.

These and other aspects and advantages of the present invention will become apparent upon reading the detailed description below.

### BRIEF DESCRIPTION OF THE DRAWINGS

The invention may take form in various components and arrangements of components, and in various steps and arrangements of steps. The drawings, in which like reference numerals denote like components throughout the several views, are only for purposes of illustrating preferred embodiments and are not to be construed as limiting the invention.

FIGS. 1-4 show the small-angle x-ray scattering patterns measured when ionic liquid surfactant treated mica and organo-clay/butyl rubber nanocomposite according to the present invention were irradiated with x-ray. The scattering of x-ray from these samples was caused by the difference of the electron densities in clay layers, surfactants and/or butyl rubber molecules. The scattering patterns were formed by the interference of secondary waves that were emitted from clay layers, surfactants and/or butyl rubber molecules. The result of the SAXS is essentially the intensity of the Fourier transform of the electron density and reflects the microstructures of the sample. Structural parameters of the sample, such as distance between clay layers, can be calculated from the peak positions and intensities, under certain assumptions.

FIG. 1 shows small angle x-ray scattering (SAXS) of an ionic liquid surfactant treated mica.

FIG. 2 shows the 2-dimentional image of small angle x-ray scattering (SAXS) of ionic liquid surfactant treated mica.

FIG. 3 shows the small angle x-ray scattering (SAXS) of an organo-clay/butyl rubber nanocomposite.

FIG. 4 shows 2-dimentional image of small angle x-ray scattering of the organo-clay/butyl rubber nanocomposite.

### DETAILED DESCRIPTION OF ILLUSTRATIVE EMBODIMENTS

The present invention relates to a method of manufacturing a clay modified rubber composition. Advantageously, favorable cure properties and low gas permeability are achieved by dispersing a clay/ionic liquid surfactant composition into the rubber.

There is no specific limitation in selecting the ionic liquid surfactant to exfoliate the clay or, in other words, to form the clay/surfactant composition or organo-clay, with a proviso that the surfactant is of ionic nature and in liquid state within the temperature range adopted to put the present invention into operation. Exemplary ionic liquid surfactants are those with a molecular structure comprising one or more linear or branched alkyl chains and a positively charged heterocyclic moiety (polar moiety). The alkyl chain can contain 1 to 50 carbon atoms. For example, the alkyl chain can be selected from the group consisting of butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, and triacontyl. Preferably, the alkyl chain can be selected from the group consisting of octyl, nonyl, decyl, undecyl, dodecyl, tridecyl, tetradecyl, pentadecyl, and hexadecyl. The positively charged heterocyclic moiety preferably has a nitrogen-containing heterocyclic structure. The number of nitrogen atoms presented in the structure can be 1, 2, or 3, preferably 2. Exemplary nitrogen-containing heterocyclic structures that can constitute the polar moiety of the ionic liquid surfactants include, but are not limited to, imidazole, 1-methylimidazole, pyrazine, pyrazole, pyridazine, pyridine, imidazolidine, piperazine, piperidine, pyrazolidine, pyrrolidine, the derivatives thereof, and the mixture thereof. Any inorganic or organic anion can be the counter ion for the positively charged heterocyclic moiety, for example, halide ion such as Cl⁻ or Br⁻, BF₄⁻, PF₆⁻, CO₃²⁻, SO₄²⁻, HSO₄⁻, or HPO₄²⁻. Advantageously, the clay/surfactant/rubber systems use “green” solvent as the surfactant, which is more easily degraded by environmental bacteria.

An example of the ionic surfactant has the formula as shown below:

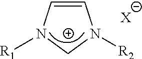

in which R₁ and R₂ are linear or branched alkyl radicals containing 1 to 50 carbon atoms, X⁻ is the counter ion and can be Cl⁻, Br⁻, BF₄⁻, PF₆⁻, CO₃²⁻, SO₄²⁻, HSO₄⁻, HPO₄²⁻ and so on.

One specific example of an ionic liquid surfactant has the formula (I) as shown below, wherein the nonpolar moiety is an octyl chain, the positively charged heterocyclic polar moiety is derived from 1-methylimidazol cation, and the counter ion is chloride:

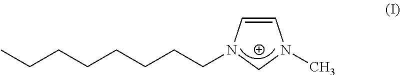

In another example, the ionic liquid surfactant has the formula (II) as shown below, wherein the nonpolar moiety is hexadecyl chain, the positively charged heterocyclic polar moiety is derived from 1-methylimidazol cation, and the counter ion is chloride:

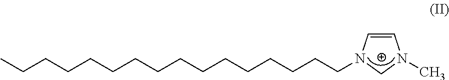 [SMILES: CCCCCCCCCCCCCCCC[NH+]1C=CN(C)C1]

The new bonds between the terminal C atom of alkyl chain and the N atom on the 3-position of 1-methylimidazol of the target ionic liquid surfactants of formulas (I) and (II) can be formed by mixing alkyl halides such as octyl chloride or hexadecyl chloride with nitrogen-containing cyclic compound such as 1-methylimidazol at elevated temperatures, such as between about 23° C. to about 500° C., preferably between about 50° C. and about 180° C., more preferably between about 75° C. and about 100° C.

The present invention provides a method of reducing negative effect of conventional surfactants on the cure properties, while maintaining the low gas permeability, of the rubber composition. Exemplary rubbers suitable to the present invention include, but not limited to, butyl rubber, BR, Hcis BR, SBR, NR and so on. The invention is particularly advantageous in association with butyl rubber. For example, tensile strength, gas permeability, and cure properties including cure capability and cure time etc. have been improved in various rubber compounds by using the ionic liquid surfactant treated clay according to the present invention.

Preparation of the clay/ionic liquid surfactant composition, according to the instant invention, is completed by exfoliating clay with the ionic liquid surfactants we have just disclosed in this description. As previously described, typical clays, prior to exfoliation by any surfactant, have a layered structure with a gap of about 0.1 nm between each layer and cations on the surface of each layer. The cations are attached by an ionic interaction with the negative surface of the clay layers, and create a net neutral charge between clay layers. A variety of clays may be used in the present invention, provided the clay is capable of being exfoliated. Exemplary clays include, but are not limited to, synthetic mica, pyrophyllite, smectites, illites, glauconites, vermiculites, polygorskines, sepiolites, allophanes, imogolites, and mixtures thereof. Preferred clays are smectites such as montmorillonite (Bentonite), beidellite, nontronite, hectorite, saponite, and sauconite.

The clay/ionic liquid surfactant compositions (organo-clays) can be developed by intercalating the ionic liquid surfactant between clay layers. For example, the clay/ionic liquid surfactant compositions can be formed by blending clay and an ionic liquid surfactant in aqueous phase, preferably in deionized water, for a sufficiently prolonged period of time. Without being bound to any theoretical mechanism, the clay is swelled by water molecules since cations of the clay such as Na⁺ and K⁺ become solubilized in the water. The adjacent clay layers are repulsed by their similar negative charges, resulting in bigger gaps between the layers. In the meanwhile, cation exchange reaction is also expected to take place between the clay cations and the surfactant cations. The bigger size of the surfactant cations makes the gaps between the clay layers even bigger. Preferably, the exfoliated clay will have an average gap greater than about 0.1 nm between layers, and more preferably a gap greater than about 3.0 nm. In the present invention, the ratio between the clay and ionic liquid surfactant can be by weight 40:60, preferably 60:40, and most preferably 70:30.

After exfoliation, the clay/ionic liquid surfactant composition alternatively referred to as the organo-clay, is dispersed into the rubber to be modified. Optionally, preferably prior to dispersing the organo-clay in the rubber, the organo-clay may be washed and dried. Preferably, the organo-clay is washed with an alcohol, such as, but not limited to, isopropanol, water or mixtures thereof. According to the present invention, the rubber so formulated has lower gas permeability without incurring a negative effect on the cure properties associated with traditional clay/surfactant systems. Since the ionic liquid surfactants according to the present invention can effectively compatibilize with the rubber, particularly butyl rubber, the clay can be further intercalated or exfoliated when the clay/ionic liquid surfactant compositions are incorporated into butyl rubber. Without being bound to any theoretical mechanism, a reason why the butyl rubber cure properties are maintained is that the ionic liquid surfactants are green solvents for many chemical reactions, including the reactions commonly required in a rubber curing process.

According to the present invention, the clay/ionic liquid surfactant composition can be advantageously incorporated into butyl rubber by wet/solvent method and by a dry mixing method under mild mixing conditions compared to conventional exfoliation processes. Such mild mixing conditions are, for example, similar to those normally used in butyl rubber mixing. The mixing may be accomplished, for example, by using any integral mixing device such as a Brabender mixer, a twinscrew extruder or a kneader, at a mixing rate of from about 20 to about 200 rpm, at a temperature of about 25° C. to about 250° C. for a period of up to about 10 minutes. In one embodiment the mixing conditions are for example, mixing in a Brabender mixer at about 60 rpm at a temperature of about 70° C. for about three minutes. Of course, the clay/ionic liquid surfactant composition can be added according to any other method known by the skilled artisan.

In accordance with the present invention, it is desirable that a suitable amount of clay/ionic liquid surfactant composition be dispersed in the butyl rubber composition to achieve low gas permeability, among other properties required by industrial applications. In any event, it is preferred that between about 1 and about 70%, more preferably, between about 3 and about 40% by weight of clay/ionic liquid surfactant composition is incorporated into the butyl rubber.

As used herein, the butyl rubber composition is intended to include isobutylene, halobutyl rubber, and copolymers of isobutylene and one or more additional monomers, such as isoprene, styrene, butadiene, and mixtures thereof. Preferably, the clay in the final product is at least about 50% exfoliated, more preferably at least about 70% exfoliated.

It is frequently desirable to include other additives known in the art to the clay/ionic liquid surfactant/butyl rubber system of the present invention. Suitable additives include stabilizers, antioxidants, conventional fillers, processing aids, accelerators, extenders, curing agents, reinforcing agents, reinforcing resins, pigments, fragrances, and the like. Other additives known in the art are also contemplated for use in the present invention. Specific examples of useful antioxidants and stabilizers include 2-(2″-hydroxy-5″-methylphenyl)benzotriazole, nickel di-butyl-di-thiocarbamate, tris(nonylphenyl)phosphite, 2,6-di-t-butyl-4-methylphenol, and the like. Exemplary conventional fillers and pigments include silica, carbon black, titanium dioxide, iron oxide, and the like. Suitable reinforcing materials are inorganic or organic products of high molecular weight. Examples include glass fibers, asbestos, boron fibers, carbon and graphite fibers, whiskers, quartz and silica fibers, ceramic fibers, metal fibers, natural organic fibers, and synthetic organic fibers. These compounding ingredients are incorporated in suitable amounts depending upon the contemplated use of the product, preferably in the range of about 1-350 parts of additives or compounding ingredients per 100 parts of the butyl rubber composition.

A further aspect of the invention relates to a rubber composition comprising an exfoliated clay including an ionic surfactant of the formula shown below or mixtures thereof and rubber:

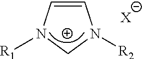

in which R₁ and R₂ are linear or branched alkyl radicals containing 1 to 50 carbon atoms, X⁻ is the counter ion and can be Cl⁻, Br⁻, BF₄⁻, PF₆⁻, CO₃²⁻, SO₄²⁻, HSO₄⁻, HPO₄²⁻ and so on. The butyl rubber composition of the invention is useful in the formation of inner liners for automobile tires and in applications requiring good damping characteristics, such as engine mounts. Other uses for the butyl rubber compositions of the invention include use in air cushions, pneumatic springs, air bellows, accumulator bags, tire-curing bladders, high temperature service hoses, and conveyor belts for handling hot materials.

In the following, the invention will be described in more detail with reference to non-limiting examples. The following examples and tables are presented for purposes of illustration only and are not to be construed in a limiting sense.

### EXAMPLES

### Preparation of Ionic Liquid Surfactants

### Example 1

### Ionic Liquid Surfactant of Formula I

654 g of 1-chloroctane (Aldrich) and 360 g of 1-methylimidazal (Aldrich) were added into a 2000 mL tri-neck round-bottom flask. A refluxing/cooling column was installed on the right neck. A thermometer was installed on the left neck. To the middle neck was connected a nitrogen purging tube that delivered the nitrogen gas below the liquid phase. The reactants were mixed with vigorous stirring using magnetic agitation at a temperature between 75 and 80° C. After 8 hours, the solution in the flask turned into a milk-like mixture. After two days, the mixture in the flask turned homogenous again. The reaction was continued for three days. Then, the product was washed with ethyl acetate five times and toluene three times. Thereafter, it was dried in vacuum for three days.

### Example 2

### Ionic Liquid Surfactant of Formula II

The procedure of Example 1 was repeated with minor changes. 868 g of 1-chlorohexadecane (Aldrich) and 570 g of 1-methylimidazal (Aldrich) were added into a 2000 mL tri-neck round-bottom flask. The reaction temperature was set to 95 to 100° C. After four hours, the milk-like solution transformed into a homogenous solution. The reaction was continued for three days. The post-treatment was the same as Example 1.

### Preparation of Clay/Ionic Liquid Surfactant Compositions

### Example 3

### Organo-Mica

60 g of the product from Example 1, 40 g of ME-100 (Coop Chemicals, Tokyo, Japan), and 800 g of deionized water were mixed together and shaken for about 16 hours. The organo-treated mica was collected through vacuum-filtration. The treated mica was further washed with isopropenol three times, and was then dried in vacuum. The clay contained 28.77% of organo-matter (i.e., the surfactant), as measured by thermo-gravity analysis (TGA). TGA was carried out on equipment manufactured by TA Instruments and Perkin Elmer, among others.

### Example 4

### Organo-Mica

80 g of the product from Example 2, 40 g of ME-100 (Coop Chemicals), and 800 g of deionized water were mixed together and shaken for about 16 hours. The organo-treated mica was collected through vacuum-filtration. The treated mica was further washed with isopropanol three times, and was then dried in vacuum. TGA was conducted in the same manner as Example 3, and the result showed that the clay contained 31.71% of organo-matter (i.e., the surfactant).

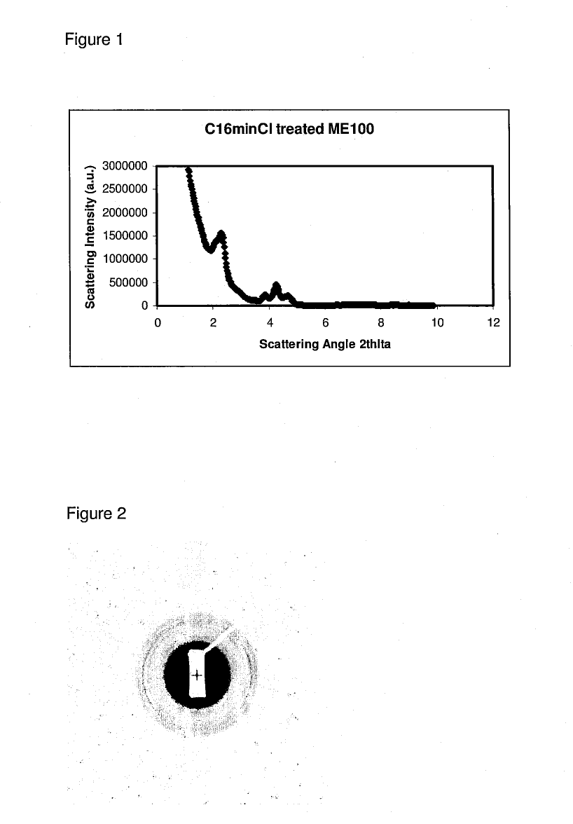

The products were checked using small angle x-ray scattering (SAXS). FIG. 1 and FIG. 2 show the SAXS result of the mica treated with ionic liquid surfactant of formula (II). Based on the scattering intensity profile between 2θ≈1.0 and 2θ≈10.0 of scattering angles, particularly the 2θ≈2.2 peak and the 2θ≈4.2 triplet peaks, calculation indicates that the mica has been intercalated by the ionic liquid surfactant, and the distances between the mica layers are approximately in the range of 30-40 Å.

### Examples 5-11

### Bromobutyl Rubber Testing

Seven bromobutyl rubber compounds were prepared according to the formulation shown in Table 1 and Table 2. The bromobutyl rubber is commercially available as Bayer XG124 Bromobutyl, BIIR. In each example, a blend of the ingredients was kneaded by the method listed in Table 3. The physical characteristics of the compositions of Examples 5-11 are shown in Table 4. Testing of the cure characteristics of rubber compounds follow the guidelines of, but were not be restricted to, ASTM-D 2084. A Monsanto Moving Die Rheometer (MDR 2000) was used to measure the cure characteristics of compounded rubbers. Cure capability (Sₘₐₓ−Sₘᵢₙ) is defined as the difference between the maximum torque and the minimum torque 90% cure time at 165° C. is defined as the time required to achieve 90% cure capability. Measurement of gas permeability was conducted by using 1 mm thick sheets according to ASTM-D1434. The gas permeability index (GPI) value was calculated according to the formula:

$$GPI = \frac{{P}_{c}}{{P}_{p}}$$

where P_{c}=permeability of the nanocomposite and Pₚ=the permeability of the polymer. Shore A Hardness at 23° C., defined as relative resistance of the rubber surface to small deformations, was measured by using a Durometer following ASTM-D2240.

TABLE 1

| | | | Amount of ionic | |
|---|---|---|---|---|
| | Organo- | Amount of | liquid surfac- | Amount of |
| | clay | organo- | tant in organo- | bromobutyl |
| | used | clay (g) | clay (g) | rubber (g) |
| Example 5 | Example 3 | 11.14 | 2.89 | 43.86 |
| Example 6 | Example 3 | 18.56 | 4.81 | 36.44 |
| Example 7 | Example 4 | 12.5 | 4.25 | 42.49 |
| Example 8 | Example 4 | 20.85 | 7.1 | 34.15 |
| Example 9 | ME-100 | 8.25 | 0 | 46.75 |
| (Control 1) | | | | |
| Example 10 | ME-100 | 13.75 | 0 | 41.25 |
| (Control 2) | | | | |
| Example 11 | No | 0 | 0 | 55 |
| (Control 3) | | | | |

TABLE 2
Final Batch Formulation (for Examples 5 to 11, by parts)

| | |
|---|---|
| Stearic Acid | 0.50 |
| Sulfur | 0.60 |
| Zinc Oxide | 0.45 |
| Altax-MBTS (Accelerator) | 0.75 |

TABLE 3
Mixing Conditions
Mixer: 60 g Brabender
Agitation Speed: 60 rpm
Mater Batch Stage

| | |
|---|---|
| Initial Temperature | 70° C. |

| | | |
|---|---|---|
| 0 | min | charging polymers |
| 0.5 | min | charging oil and Carbon Black |
| 3.0 | min | drop |

Final Batch Stage

| | |
|---|---|
| Initial Temperature | 70° C. |

| | | |
|---|---|---|
| 0 | sec | charging master stock |
| 2 | min | charging curing agent and accelerators |
| 2.5 | min | drop |

TABLE 4
Physical properties of the test bromobutyl rubbers.

| | HSA¹ | GPI | CC² | CT³ | M&S⁴ | STREM⁵ | STRAM⁶ |
|---|---|---|---|---|---|---|---|
| Example 5 | 35 | | 2.865 | 13.87 | | | |
| Example 6 | 38 | | 2.987 | 16.43 | | | |
| Example 7 | 50 | 50.2 | 2.846 | 9.22 | 105 | 909 | 844 |
| Example 8 | 53 | 60 | 3.445 | 13.48 | | | |
| Example 9 | 40 | 86.3 | 2.811 | 13.01 | 18.9 | 373 | 772 |
| (Control | | | | | | | |
| 1) | | | | | | | |
| Example | 42 | 66.4 | 3.161 | 16.74 | | | |
| 10 | | | | | | | |
| (Control | | | | | | | |
| 2) | | | | | | | |
| Example | 33 | 100 | 2.237 | 8.69 | 14 | 324 | 812 |
| 11 | | | | | | | |
| (Control | | | | | | | |
| 3) | | | | | | | |

Note:
¹HSA means Hardness Shore A at 23° C.
²CC means Cure Capability (Sₘₐₓ − Sₘᵢₙ) (kg-cm).
³CT means 90% Cure time 165° C. (Min.).
⁴M&S means modulus at 23° C. and 35% strain.
⁵STREM means stress at maximum (psi).
⁶STRAM means strain at maximum (%).

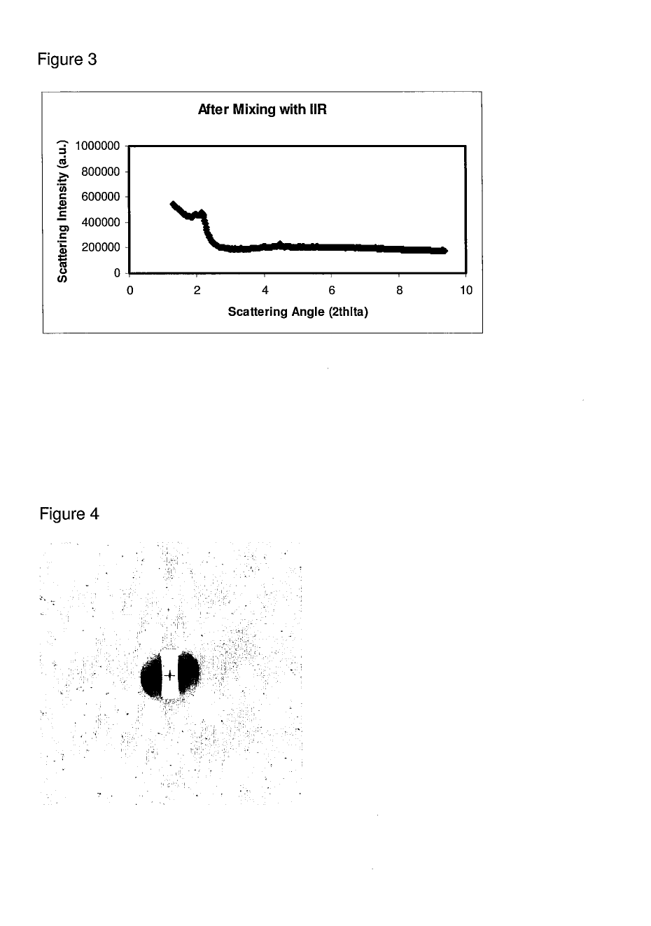

The addition of exfoliated clay from example 4 into butyl rubber has significantly lowered gas permeability of the butyl rubber, as compared to control samples. In Examples 5, 6, 7, and 8, various amounts of exfoliated clay from examples 3 or 4 were added to butyl rubber, and the samples have maintained approximately the same cure capability and cure time as those of the control samples. FIGS. 3 and 4 show the SAXS results for Example 8. Comparing to FIGS. 1 and 2, FIGS. 3 and 4 have an increased baseline, disappeared triplet peak around 2θ≈4.2, and decreased peak values between 2θ≈1.0 and 2θ≈3.0. FIGS. 3 and 4 indicate that the clay exists in a less organized form, reflecting that the organo-clay has been further exfoliated in the rubber compound.

### Examples 12-14

### Natural Rubber Testing

In a manner similar to the procedures of Examples 5-11, natural rubber commercially available as TC10 NR from Firestone Company has been tested with the organo-clay of Example 4. The testing results are tabulated in Table 5.

TABLE 5
Physical properties of the test TC10 NR.

| | Formulation | GPI | CC² | CT³ | M&S⁴ | STREM⁵ | STRAM⁶ |
|---|---|---|---|---|---|---|---|
| Example 12 | Ex. 4 Organo-clay + | 30.7 | 6.47 | 2.54 | 143 | 1949 | 765 |
| | TC10 NR | | | | | | |
| Example 13 | ME-100 + TC10 | | 8.19 | 3.43 | 28 | 692 | 679 |
| | NR (Control) | | | | | | |
| Example 14 | TC10 NR (Control) | 100 | 5.89 | 2.04 | 19 | 1149 | 862 |

### Examples 15-17

### Styrene-Butadiene Rubber (SBR) Testing

In a manner similar to the procedures of Examples 5-11, solution SBR commercially available as HX263 from Firestone Company has been tested with the organo-clay of Example 4. The testing results are tabulated in Table 6.

TABLE 6
Physical properties of the test HX263 SBR.

| | Formulation | GPI | CC² | CT³ | M&S⁴ | STREM⁵ | STRAM⁶ |
|---|---|---|---|---|---|---|---|
| Example 15 | Ex. 4 Organo-clay + | 38.3 | 8.0 | 7.62 | 159 | 1155 | 619 |
| | HX263 | | | | | | |
| Example 16 | ME-100 + HX263 | | 11.07 | 16.75 | 40 | 335 | 242 |
| | (Control) | | | | | | |
| Example 17 | HX263 (Control) | 100 | 8.58 | 16.86 | 28 | 176 | 200 |

### Examples 18-20

### Hcis-Butyl Rubber Testing

In a manner similar to the procedures of Examples 5-11, Hcis-BR commercially available as Diene 600 from Firestone Company has been tested with the organo-clay of Example 4. The testing results are tabulated in Table 7.

TABLE 7
Physical properties of the test Diene 600 Hcis-BR.

| | Formulation | GPI | CC² | CT³ | M&S⁴ | STREM⁵ | STRAM⁶ |
|---|---|---|---|---|---|---|---|
| Example 18 | Ex. 4 Organo-clay + | 30.7 | 8.6 | 4.56 | 121 | 498 | 548 |
| | Diene 600 | | | | | | |
| Example 19 | ME-100 + Diene | | 10.73 | 17.49 | 39 | 186 | 251 |
| | 600 (Control) | | | | | | |
| Example 20 | Diene 600 (Control) | 100 | 8.78 | 16.21 | 26 | 167 | 185 |

### Examples 21-23

### Solution Butyl Rubber Testing

In a manner similar to the procedures of Examples 5-11, solution butyl rubber commercially available as Diene 40NF from Firestone Company has been tested with the organo-clay of Example 4. The testing results are tabulated in Table 8.

TABLE 8
Physical properties of the test Diene 40NF Soln BR.

| | Formulation | GPI | CC² | CT³ | M&S⁴ | STREM⁵ | STRAM⁶ |
|---|---|---|---|---|---|---|---|
| Example 18 | Ex. 4 Organo-clay + | 34.1 | 7.95 | 5.76 | 136 | 555 | 523 |
| | Diene 40NF | | | | | | |
| Example 19 | ME-100 + Diene | | 12.68 | 17.50 | 42 | 255 | 177 |
| | 40NF (Control) | | | | | | |
| Example 20 | Diene 40NF (Control) | 100 | 10.03 | 18.36 | 27 | 156 | 162 |

The results of Examples 5-20 show that under 15 wt % of loading, the tensile strengths of the test compounds were all better than that of the controls. Particularly, SBR shows the strongest interactions with the organo-mica, and it displays an 800% improvement in the tensile strength. Other benefits of using the treated ME100 include, for example, improved gas permeability and cure properties.

The butyl rubber compositions of the present invention can be formulated into any component or article for which butyl rubber is typically utilized. Typical articles for which the butyl rubber compositions can be used include, but are not limited to, inner-tubes and tire inner liners, sidewall, thread rubber, hose, containers, air cushions, pneumatic sprays, air bags, tire-curing bladders, air bellows, accumulator bags, pharmaceutical closures, high temperature hoses and conveyor belts, damping mounts for engines and the like.

The invention has been described with reference to the exemplary embodiments. Modifications and alterations may appear to others upon reading and understanding the specification. The invention is intended to include such modifications and alterations insofar as they come within the scope of the claims. The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

It is claimed:

1. A method of making a clay modified butyl rubber composition comprising:
exfoliating a clay in the presence of an ionic surfactant and combining said exfoliated clay with a butyl rubber; and
wherein the ionic surfactant comprises a compound represented by the formula: 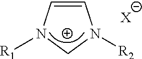
in which R₁ and R₂ are linear or branched alkyl radicals containing 1 to 50 carbon atoms, and X— is Cl⁻, Br⁻, BF₄⁻, PF₆⁻, CO₃²⁻, SO₄²⁻, HSO₄⁻, or HPO₄²⁻.

2. The method of claim 1, wherein R₁ or R₂ is selected from the group consisting of butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, and triacontyl.

3. The method of claim 1, wherein a cationic portion of the ionic surfactant comprises a compound of formula (I) or (II) as showed below:

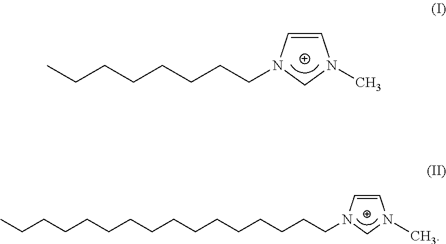

5. The method of claim 1, comprising reacting octyl chloride or hexadecyl chloride or mixtures thereof and I-methylimidazol to form the ionic surfactant.

6. The method of claim 1, wherein the clay is selected from mica, pyrophyllite, smectites, illites, glauconites, vermiculites, polygorskines, sepiolites, allophanes, imogolites, and mixtures thereof.

7. The method of claim 1, wherein said exfoliated clay comprises between about 3% and about 70% by weight of the rubber composition.

8. A rubber composition comprising an exfoliated clay including an ionic surfactant and wherein the ionic surfactant comprises a compound represented by the formula: 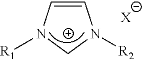
in which R₁ and R₂ are linear or branched alkyl radicals containing 1 to 50 carbon atoms, X— is Cl⁻, Br⁻, BF₄⁻, PF₆⁻, CO₃²⁻, SO₄²⁻, HSO₄⁻, or HPO₄²⁻.

9. The rubber composition of claim 8, wherein R₁ or R₂ is selected from the group consisting of butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, and triacontyl.

10. The rubber composition of claim 8, wherein a cationic portion of the ionic surfactant comprises a compound formula (I) or (II) as showed below:

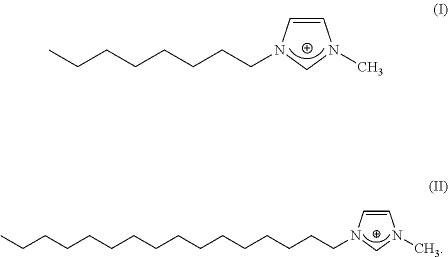

11. The rubber composition of claim 8, wherein the clay is selected from mica, pyrophyllite, smectites, illites, glauconites, vermiculites, polygorskines, sepiolites, allophanes, imogolites, and mixtures thereof.

12. The rubber composition of claim 8, wherein said exfoliated clay comprises between about 3% and about 70% by weight of the rubber composition.

13. The rubber composition of claim 8, wherein the rubber composition is incorporated in a tire inner liner.

14. A tire product comprising a nano-composite comprising
(a) a surfactant cation comprising of an alkyl chain unit and a heterocyclic cationic unit;
(b) a clay; and
(c) a polymer;
wherein said clay is exfoliated or intercalated by the surfactant cation, the polymer, or both the surfactant cation and polymer;
the alkyl chain unit is selected from the group consisting of: butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, and triacontyl;
the heterocyclic cationic unit comprises imidazole, 1-methylimidazole, pyrazine, pyrazole, pyridazine, pyridine, imidazolidine, piperazine, piperidine, pyrazolidine, pyrrolidine, the derivatives thereof and mixtures thereof.

15. The tire product of claim 14, wherein the surfactant cation comprises a compound represented by the formula shown below: 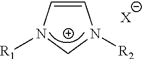
wherein R₁ and R₂ are linear or branched alkyl radicals containing 1 to 50 carbon atoms, and at least one of R₁ or R₂ is the alkyl chain unit.

16. The tire product of claim 14, wherein the clay is selected from mica, pyrophyllite, smectites, illites, glauconites, vermiculites, polygorskines, sepiolites, allophanes, imogolites, and mixtures thereof.

17. The tire product of claim 14, wherein said exfoliated clay comprises between about 3% and about 70% by weight of the rubber composition.

18. The tire product of claim 14, wherein the rubber composition is incorporated in a tire inner liner.

19. The tire product of claim 14, wherein the surfactant cation comprises a compound formula (I) or (II) as shown below: [chemical structure]
